(19) United States
(12) Patent Application Publication
(10) Pub. No.: US 2010/0304636 A1
(43) Pub. Date: Dec. 2, 2010

(54) PACIFIER ATTACHMENT DEVICE

(76) Inventor: Sarah Seiz, South Plainfield, NJ (US)

Correspondence Address: WALTER J. TENCZA JR., 100 Menlo Park, Suite 210, Edison, NJ, 08837, US

(21) Appl. No.: 12/494,866

(22) Filed: Jun. 30, 2009

Related U.S. Application Data
(60) Provisional application No. 61/216,989, filed on May 26, 2009.

(51) Int. Cl. A63H 3/00; A63H 5/00; A61J 17/00

(52) U.S. Cl. 446/72; 446/81; 606/234

(57) ABSTRACT

An apparatus including a stuffed animal, a pacifier; and an attachment device fixed to the stuffed animal. The attachment device may be flexible and is configured so that it can be inserted into an opening of the pacifier and thereafter the attachment device can be attached to itself to hold the pacifier onto the stuffed animal. The attachment device may include a material and first and second connectors fixed to the material. The first connector may connect to the second connector to attach the attachment device to itself to hold the pacifier onto the stuffed animal.

### CROSS REFERENCE TO RELATED APPLICATION(S)

The present application claims the priority of U.S. provisional patent application Ser. No. 61/216,989, filed on May 26, 2009, titled “Pacifier Guardian”.

### FIELD OF THE INVENTION

This invention relates to methods and apparatus concerning attaching pacifiers to stuffed animals.

### BACKGROUND OF THE INVENTION

There are various devices known in the prior art for attaching pacifiers to stuffed animals. For example, there is a device called Paci Plushies (trademarked) which has a plastic extension fixed to a mouth of a stuffed animal. A button type pacifier can be inserted into a ring of the plastic extension in order to attach the pacifier to the plastic extension. The plastic ring typically is configured to work with button type pacifiers of a particular size. In addition, U.S. Pat. No. 6,666,740 to Schneider discloses a stuffed toy which discloses a projecting portion A6, such as a head of the stuffed toy, which is fixed to a tab B3 on a pacifier, such as by stitching, indicated as C. (Schneider, col. 1, ln. 50-col. 2, ln. 24). The Schneider patent requires a pacifier with a tab (Schnieder, col. 1, lns. 25-30) and is not compatible with pacifiers not having such a tab.

The Paci Plushies (trademarked), and U.S. Pat. No. 6,666,740 are typically configured to be too small and tend to slip through crib rails.

### SUMMARY OF THE INVENTION

One or more embodiments of the present invention include a method and apparatus of attaching a pacifier to a stuffed animal. In accordance with one or more embodiments of the present invention, the stuffed animal may include an auditory component which aids in location of the stuffed animal and an attached pacifier and creates an interactive element to the stuffed animal and pacifier.

In one or more embodiments an apparatus is provided comprising a stuffed animal, a pacifier, and an attachment device fixed to the stuffed animal. The attachment device may be flexible and may be configured so that it can be inserted into an opening of the pacifier and then the attachment device can be attached to itself to hold the pacifier onto the stuffed animal. The attachment device may include a material and first and second connectors may be fixed to the material. The first connector may connect to the second connector to attach the attachment device to itself to hold the pacifier onto the stuffed animal. The material may be a strip of material. The strip of material may be elongated and may be about three inches in length and about one inch in width. The opening of the pacifier may have a dimension which is about one inch in width. The attachment device may be fixed to a limb of the stuffed animal.

One or more embodiments of the present invention may include a method comprising fixing an attachment device onto a stuffed animal, inserting an end of the attachment device through an opening of a pacifier, and thereafter attaching the attachment device to itself to hold the pacifier onto the stuffed animal.

### BRIEF DESCRIPTION OF THE DRAWINGS

FIG. 1 shows a perspective view of a pacifier and an attachment device along with a front view of a stuffed animal in accordance with an embodiment of the present invention;

FIG. 2 shows a perspective view of the pacifier and the attachment device of FIG. 1 along with a front view of another stuffed animal, in accordance with another embodiment of the present invention;

FIG. 3A shows a top view of the attachment device of FIG. 1 attached to a portion of the stuffed animal of FIG. 1, with the attachment device shown in a first or open state;

FIG. 3B shows a side view of the attachment device of FIG. 1 attached to the portion of the stuffed animal of FIG. 1, with the attachment device shown in a second or closed state;

FIG. 3C shows a top view of the attachment device of FIG. 1 attached to the portion of the stuffed animal of FIG. 1, with the attachment device shown in the second or closed state;

FIG. 3D shows a top view of the pacifier of FIG. 1;

FIG. 3E shows a side view of the pacifier of FIG. 1 attached to the attachment device of FIG. 1, with the attachment device shown in the second or closed state;

FIG. 3F shows a top view of the attachment device of FIG. 1 attached to the portion of the stuffed animal of FIG. 1, with the attachment device shown in the second or closed state and the with attachment device attached to the pacifier of FIG. 3D;

FIG. 4A shows a side view of a button type pacifier, a connector, an attachment device, and a portion of a stuffed animal in accordance with another embodiment of the present invention, with the button type pacifier not inserted into the connector;

FIG. 4B shows a top view of the connector connected to the attachment device of FIG. 4A;

FIG. 4C shows a side view of the button type pacifier, the connector, the attachment device, and a portion of the stuffed animal of FIG. 4A, in accordance with another embodiment of the present invention, with the button type pacifier inserted into the connector;

FIG. 4D shows a top view of the button type pacifier connected to the connector, which is connected to the attachment device of FIG. 4A; and

FIG. 4E shows a top view of the connector of FIGS. 4B and 4D.

### DETAILED DESCRIPTION OF THE DRAWINGS

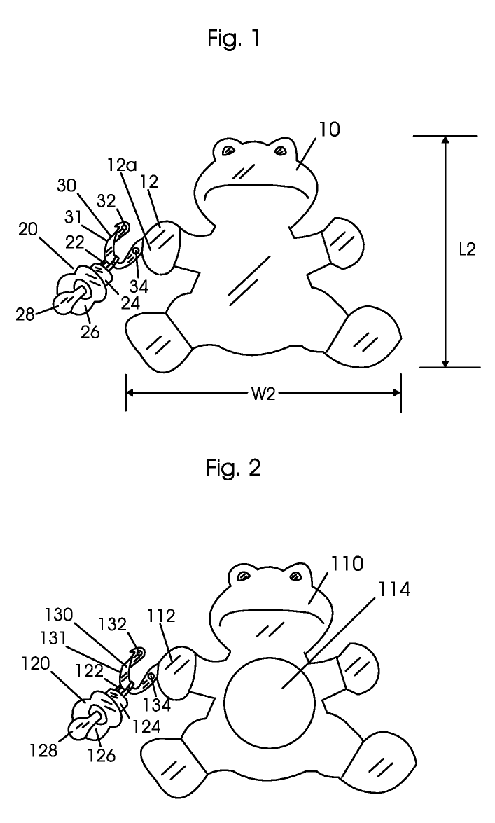

FIG. 1 shows a perspective view of a pacifier 20 and an attachment device 30 along with a front view of a stuffed animal 10 in accordance with an embodiment of the present invention.

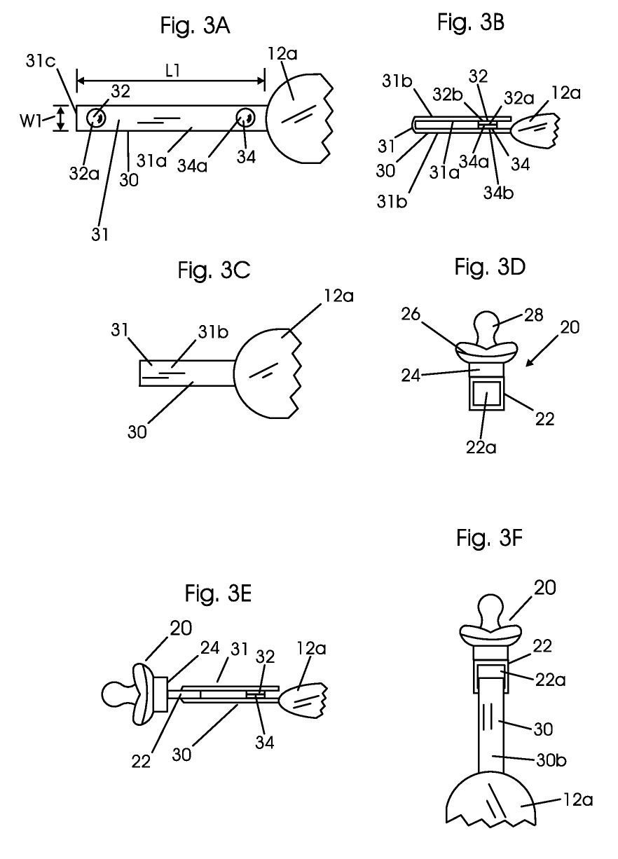

The pacifier 20 may be a pacifier known in the art. The pacifier 20 may include a connection portion 22, a base 24, an annular portion 26, and a mouthpiece 28. The connection portion 22, base 24, and the annular portion 26 may be made of plastic, while the mouth piece 28 may be made of a material, such as a synthetic material suitable to be placed in an infant's mouth. The annular portion 26 prevents the pacifier 20 from being swallowed. The connection portion 22 may be square as shown in FIG. 3D or may be circular or any other shape used for a pacifier known in the art.

The stuffed animal 10 may be a known stuffed animal of any type and any size. However, the stuffed animal may have specific dimensions in accordance with one or more embodiments of the present invention. It is preferred that the stuffed animal 10 have a width W2 of approximately nine inches (tip of one limb to the tip of other limb), length L2 of approximately of seven inches (bottom of torso or legs to tip of head) and depth of two and one half (2½) inches. The length L2, width W2 and the depth of the stuffed animal 10 shown in FIG. 1 should all be at least two and one half inches to prevent the stuffed animal 10 from falling through spaces between crib bars, slats, or rails. These dimensions for the stuffed animal 10 help to prevent the stuffed animal 10 from falling through bars of a crib. Bars of a crib are typically no more than two and three-eighths inches apart. Cribs must meet all recommended safety standards. The bars or slats of the crib railing are no more than two and three eighths inches apart so a baby can't wedge his head between the bars or slats of a crib. The Paci Plushies (trademarked) prior device, and U.S. Pat. No. 6,666,740 dimensions are typically configured to be smaller in length, width, and depth, allowing them to slip through the spaces between crib bars, slats, or rails. In addition, the stuffed animal, in accordance with one or more embodiments of the present invention, may have a material or auditory component inside of it which makes a noise, such as a rattle noise, when the stuffed animal is shaken or moved. The auditory component can be bells, chimes, crinkle material, or any other device that creates a stimulating noise for the baby to hear. The stuffed animal 10 has four limbs, including an arm, paw, or hand 12. The arm, paw, or hand 12 has a portion 12a to which a proximal end of the attachment device 30 is attached.

At rest, the limbs of the stuffed animal 10 are typically spread outward as shown in FIG. 1 in order to lay flat against the body of a baby when being held. The stuffed animal may have a width, W2 shown in FIG. 1, of nine inches (tip of one limb to the tip of other limb), a length, L2, of of seven inches (bottom of legs or torso, depending on the stuffed animal's shape to tip of head) and a depth of at least two and one half inches. The depth of at least two and one half inches, and a width W2 and a length L2 of at least two and one half inches makes it difficult for the stuffed animal to fit through spaces of less than two and one half inches which are found between crib rails in many infant cribs.

Modifications can be made to the stuffed animal 10 of FIG. 1 or the stuffed animal 110 of FIG. 2 that will still allow for the preservation of the original intent and purpose of the present invention in one or more embodiments. The stuffed animals 10 of FIG. 1 and 110 of FIG. 2 may be or may be replaced by another shape such as other animals, creatures, angels, people, or other geometric shapes. Other geometric shapes includes having a blanket body where the torso of the stuffed animal is replaced by a square of soft fabric, such as a torso of approximately ten inches measured diagonally,

The stuffed animal 10 may have an inner cavity or chamber which may contain any material or auditory component, such as cellophane to aide in auditory stimulation, I.e. the stuffed animal 10 may be configured to make a noise when it is touched or moved.

FIG. 3A shows a top view of the attachment device 30 attached to a portion 12a of the stuffed animal of FIG. 1, with the attachment device 30 shown in a first or open state. The attachment device 30 includes a material 31, such as a strip of cloth material. The material 31 has a side 31a shown in FIG. 3A and an opposite side 31b shown partially in FIG. 3C. Connectors, such as snap connectors, buttons, or Velcro (trademarked) strips Connectors 34 and 32 are attached to the material 31. The connectors 32 and 34 also have ends 32b and 34b, which are fixed to the inner side 31a of the material 31. The button connectors have ends 34a and 32a which connect and/or snap together as shown in FIG. 3B. The ends 34a and 32a may be any type of connection or attachment devices, such as snap connectors, button connectors, or pieces of Velcro (trademarked) which can be connected, or attached together, and can also be detached from each other. FIG. 3B shows a side view of the attachment device 30 attached to the portion 12a of the stuffed animal 10, which the attachment device 30 shown in a second state or closed state where a loop is formed by connecting material 31 to itself using connectors 34 and 32. FIG. 3C shows a top view of the attachment device 30 attached to the portion 12a of the stuffed animal 10, with the attachment device 30 shown in the second or closed state as in FIG. 3B, so that the material 31 and connectors 32 and 34 form a closed loop.

FIG. 3D shows a top view of the pacifier 20 of FIG. 1. FIG. 3E shows a side view of the pacifier 20 attached to the attachment device 30 of FIG. 1, with the attachment device 30 shown in the second or closed state. FIG. 3F shows a top view of the attachment device 30 of FIG. 1 attached to the portion 12a of the stuffed animal 10, with the attachment device 30 shown in a second or closed state and with the attachment device 30 attached to the pacifier 20. An end 31c of the material 31 may be inserted through an opening 22a of the connection portion 22 of the pacifier 20, and then the connectors 32 and 34 may be snapped together to hold the pacifier 20 to the stuffed animal portion 12a and thus to the stuffed animal 10, as shown by FIGS. 3E and 3F.

The attachment device 30 may be a strip of cloth which may be elongated and may have a length, L1, shown in FIG. 3A length of about three inches, and a width, W1, of about one inch.

FIG. 2 shows a perspective view of a pacifier 120 and an attachment device 130 along with a front view of a stuffed animal 110, in accordance with another embodiment of the present invention. The pacifier 120 may be the same as the pacifier 20 and may include components 122, 124, 126, and 128 which correspond to components 22, 24, 26, and 28 of FIG. 1. The attached device 130 may be the same as the attachment device 30 of FIG. 1, and may include material 131, and connectors 132 and 134, which may be the same as the components 31, 32, and 34. The stuffed animal 110 may include a limb 112 which may be the same as the limb 12 in FIG. 1. The stuffed animal 110 may have a large circular opening 114, which is large enough for insertion of an infant's hand, so that the stuffed animal 110 can be easily picked up by an infant.

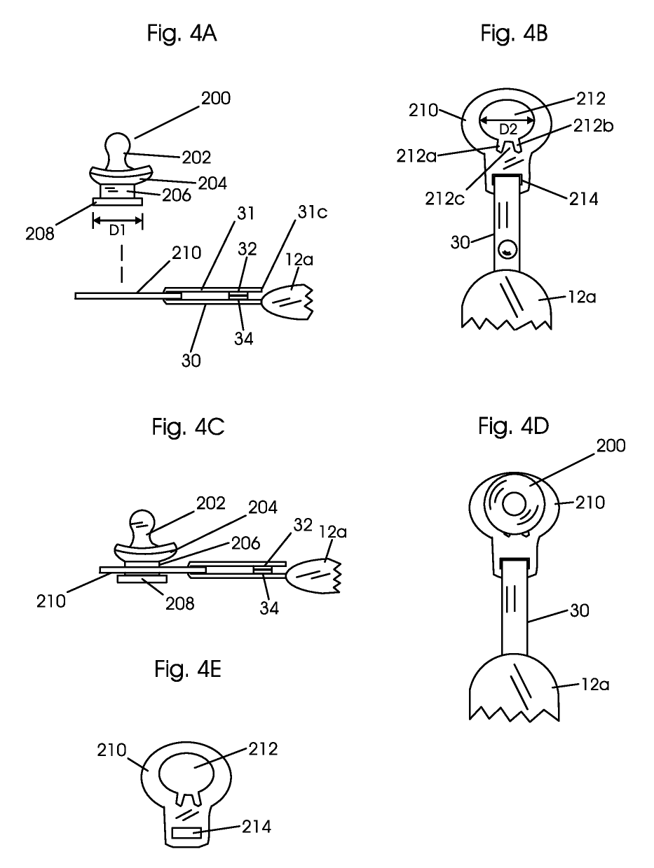

FIG. 4A shows a side view of a button type pacifier 200, a connector 210, an attachment device 30, and a portion 12a of the stuffed animal 10 of FIG. 1 in accordance with another embodiment of the present invention, with the button type pacifier 200 not inserted into the connector 210. FIG. 4B shows a top view of the connector 210 connected to the attachment device 30. FIG. 4C shows a side view of the button type pacifier 200, the connector 210, an attachment device 30, and a portion 12a of a stuffed animal 10 in accordance with another embodiment of the present invention, with the button type pacifier 200 inserted into the connector 210. FIG. 4D shows a top view of the button type pacifier 200 connected to the connector 210, which is connected to the attachment device 30. FIG. 4E shows a top view of the connector 210.

The button type pacifier 200 may be of a type known in the art, and may include a mouth piece 202, an annular portion 204, a base 206, and an outer ring portion 208. The outer ring portion 208 is configured to snap into an opening 212 of the connector 210. The outer ring 208 may be circular or substantially circular and may have a diameter D1. The opening 212 may be substantially circular with the exception of gaps or slots 212a and 212b, and protrusion 212c, which may make it easier for the outer ring portion 208 to fit within the opening 212 and to be held by connector 210. The connector 210 may be made of silicon. The opening 212 may have an inner diameter of D2 which may be slightly less than the diameter D1 of the outer ring portion 208 of pacifier 200. The connector 210 may be made of flexible plastic. The outer ring portion 208, the base portion 206, and the annular portion 204 of the button type pacifier 200 may be made of a hard plastic. The mouth piece 202 is typically made of a synthetic material which is suitable to put in an infant's mouth.

The connector 210 includes a slot 214 shown in FIG. 4E, through which end 31c of the material 31 of the attachment device 32 can be inserted, and then the connectors 32 and 34 can be snapped together to attach the connector 210 to the portion 12a of the stuffed animal 10.

The connector or connector piece 210 may be a connector known in the art. Such connectors typically have an elongated slot 214 with a length of about nine sixteenths of an inch and a width and height of about one eighth of an inch. Alternatively, the connector 210 may have an elongated slot 214 with a length of about one inch or a length of about one and one sixteenth inches, a width of about one eighth of an inch, and a height of about three sixteenths ( 3/16) of an inch. This longer length and height for the slot 214 compared with the prior art, is done to allow about a one inch width, W1, of material 31 along with connector 32 to fit through the slot 214, without being bunched up or folded.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a stuffed animal;
an attachment device fixed to the stuffed animal; and
wherein the attachment device is flexible and is configured so that it can be inserted into an opening of a pacifier and thereafter the attachment device can be attached to itself to hold a pacifier onto the stuffed animal.

2. The apparatus of claim 1 further comprising
the pacifier.

3. The apparatus of claim 1 wherein
the attachment device includes a material and first and second connectors are fixed to the material; and
wherein the first connector connects to the second connector to attach the attachment device to itself to hold the pacifier onto the stuffed animal.

4. The apparatus of claim 1 wherein
the material is a strip of material.

5. The apparatus of claim 4 wherein
the strip of material is elongated and is about three inches in length and about one inch in width.

6. The apparatus of claim 5 wherein
the opening of the pacifier has a dimension which is about one inch in width.

7. The apparatus of claim 1 wherein
the attachment device is fixed to a limb of the stuffed animal.

8. The apparatus of claim 1 wherein
the stuffed animal includes an auditory component which makes a sound when the stuffed animal is moved.

9. The apparatus of claim 1 wherein
the stuffed animal has a width, a length, and a depth,
and wherein each of the width, the length and the depth of the stuffed animal is greater than or equal to two and one half inches.

10. An apparatus comprising:
a stuffed animal;
an attachment device fixed to the stuffed animal; and
a connector having a substantially circular opening and a slot;
wherein the pacifier is configured so that it can be inserted into the substantially circular opening of the connector and held by the connector;
wherein the attachment device is configured so that it can be inserted into the slot of the connector and thereafter the attachment device can be to itself to hold the connector and the pacifier onto the stuffed animal.

11. The apparatus of claim 10 wherein
the stuffed animal has a width, a length, and a depth,
and wherein each of the width, the length and the depth of the stuffed animal is greater than or equal to two and one half inches.

12. A method comprising
fixing an attachment device onto a stuffed animal;
inserting an end of the attachment device through an opening of a pacifier;
and thereafter attaching the attachment device to itself to hold the pacifier onto the stuffed animal.

13. The method of claim 12 wherein
the attachment device includes a material and first and second connectors are fixed to the material; and
wherein the first connector connects to the second connector to attach the attachment device to itself to hold the pacifier onto the stuffed animal.

14. The method of claim 12 wherein
the material is a strip of material.

15. The method of claim 14 wherein
the strip of material is elongated and is about three inches in length and about one inch in width.

16. The method of claim 15 wherein
the opening of the pacifier has a dimension which is about one inch in width.

17. The method of claim 12 wherein
the attachment device is fixed to a limb of the stuffed animal.

18. The method of claim 12 wherein
the stuffed animal includes an auditory component which makes a sound when the stuffed animal is moved.

19. The method of claim 12 wherein
the stuffed animal has a width, a length, and a depth,
and wherein each of the width, the length and the depth of the stuffed animal is greater than or equal to two and one half inches.
